(19) United States
(12) Patent Application Publication
(10) Pub. No.: US 2022/0170310 A1
(43) Pub. Date: Jun. 2, 2022

(54) OBSTACLE DETECTION DEVICE, METHOD, AND PROGRAM

(71) Applicant: AISIN CORPORATION, Kariya (JP)

(72) Inventors: Kota Katahara, Kariya-shi (JP); Ryu Miyashiro, Kariya-shi (JP)

(73) Assignee: AISIN CORPORATION, Kariya (JP)

(21) Appl. No.: 17/536,921

(22) Filed: Nov. 29, 2021

(30) Foreign Application Priority Data
Nov. 30, 2020 (JP) 2020-199013

(51) Int. Cl. E05F 15/73; E05F 15/40

(52) U.S. Cl. CPC E05F 15/73; E05F 15/40; E05F 2015/763; E05Y 2900/531; E05Y 2400/44; E05Y 2400/54; E05F 2015/767

(57) ABSTRACT

An obstacle detection device includes: an ultrasonic sensor signal processing unit detecting, of a distance to an obstacle and a shape of the obstacle, at least the distance based on an output of an ultrasonic sensor disposed in a door of a vehicle, the ultrasonic sensor detecting the distance within a predetermined detection range by ultrasonic waves; a camera image processing unit detecting at least one of the distance and the shape based on an output of a camera of the vehicle, the camera imaging an area including a trajectory range of the door when being opened and a detection range of the ultrasonic sensor; and a controller performing an opening operation control of opening the door to a pop-up position based on detection results of the ultrasonic sensor signal processing unit and the camera image processing unit when the distance is less than a predetermined distance.

### CROSS REFERENCE TO RELATED APPLICATIONS

This application is based on and claims priority under 35 U.S.C. § 119 to Japanese Patent Application 2020-199013, filed on Nov. 30, 2020, the entire content of which is incorporated herein by reference.

### TECHNICAL FIELD

This disclosure relates to an obstacle detection device, a method, and a program.

### BACKGROUND DISCUSSION

In the related art, there has been known a technique of detecting an obstacle around a door of a vehicle using a camera, an ultrasonic sensor, or the like, and controlling the door (for example, controlling a door opening degree) not to come into contact with the detected obstacle.

Examples of the related art include JP 2018-009386A (Reference 1) and JP 2005-076408A (Reference 2).

In a device that controls a door using a monocular camera or the like, an exact distance to the obstacle cannot be known when the monocular camera does not move. For this reason, the door needs to be stopped at a sufficient distance to the obstacle, which may make it difficult to get on the vehicle.

In addition, even when an obstacle having a complicated shape is detected by the ultrasonic sensor alone, a portion that may come into contact with the door first may not be detected, and the door may collide with the obstacle due to a large detection error.

A need thus exists for an obstacle detection device, a method, and a program which are not susceptible to the drawback mentioned above.

### SUMMARY

An obstacle detection device according to an embodiment including: an ultrasonic sensor signal processing unit configured to detect, of a distance to an obstacle and a shape of the obstacle, at least the distance based on an output of an ultrasonic sensor disposed in a door of a vehicle, the ultrasonic sensor being configured to detect the distance to the obstacle within a predetermined detection range by ultrasonic waves; a camera image processing unit configured to detect at least one of the distance to the obstacle and the shape of the obstacle based on an output of a camera of the vehicle, the camera being configured to image an area including a trajectory range of the door of the vehicle when being opened and a detection range of the ultrasonic sensor; and a controller configured to perform an opening operation control of opening the door to a pop-up position based on a detection result of the ultrasonic sensor signal processing unit and a detection result of the camera image processing unit when the distance to the obstacle is less than a predetermined distance.

A method according to an embodiment is a method performed by an obstacle detection device to which an output from an ultrasonic sensor disposed in a door of a vehicle and an output of a camera of the vehicle are input, the ultrasonic sensor being configured to detect a distance to an obstacle within a predetermined detection range by ultrasonic waves, the camera being configured to image an area including a trajectory range of the door of the vehicle when being opened and a detection range of the ultrasonic sensor, the method including: a first step of detecting, of the distance to the obstacle and a shape of the obstacle, at least the distance based on the output of the ultrasonic sensor; a second step of detecting at least one of the distance to the obstacle and the shape of the obstacle based on the output of the camera; and a third step of performing an opening operation control of opening the door to a pop-up position based on detection results of the first step and the second step when the distance to the obstacle is less than a predetermined distance.

A program according to an embodiment is a program that controls, by a computer, an obstacle detection device to which an output from an ultrasonic sensor disposed in a door of a vehicle and an output of a camera of the vehicle are input, the ultrasonic sensor being configured to detect a distance to an obstacle within a predetermined detection range by ultrasonic waves, the camera being configured to image an area including a trajectory range of the door of the vehicle when being opened and a detection range of the ultrasonic sensor, the program causing the computer to function as: a first unit configured to detect, of the distance to the obstacle and a shape of the obstacle, at least the distance based on the output of the ultrasonic sensor; a second unit configured to detect at least one of the distance to the obstacle and the shape of the obstacle based on the output of the camera; and a third unit configured to perform an opening operation control of opening the door to a pop-up position based on detection results of the first unit and the second unit when the distance to the obstacle is less than a predetermined distance.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic configuration block diagram of an obstacle detection device according to an embodiment;

FIG. 2 is a plan view of a vehicle provided with the obstacle detection device according to the embodiment;

FIG. 3 is a right-side view of the vehicle provided with the obstacle detection device according to the embodiment;

FIG. 4 shows states of the embodiment;

FIG. 5 is an operation flowchart of the embodiment;

FIGS. 6A and 6B show a state when a wall-shaped obstacle is detected by an ultrasonic sensor;

FIGS. 7A and 7B show a state when a pole-shaped obstacle is detected by the ultrasonic sensor; and

FIG. 8 shows a state when a guardrail, which is an obstacle having a complicated shape, is detected.

### DETAILED DESCRIPTION

Hereinafter, an embodiment disclosed here will be described. Configurations of the embodiment described below and actions, results, and effects obtained by these configurations are examples. The disclosure can be implemented by configurations other than those disclosed in the following embodiment, and at least one of various effects based on basic configurations and derived effects can be obtained.

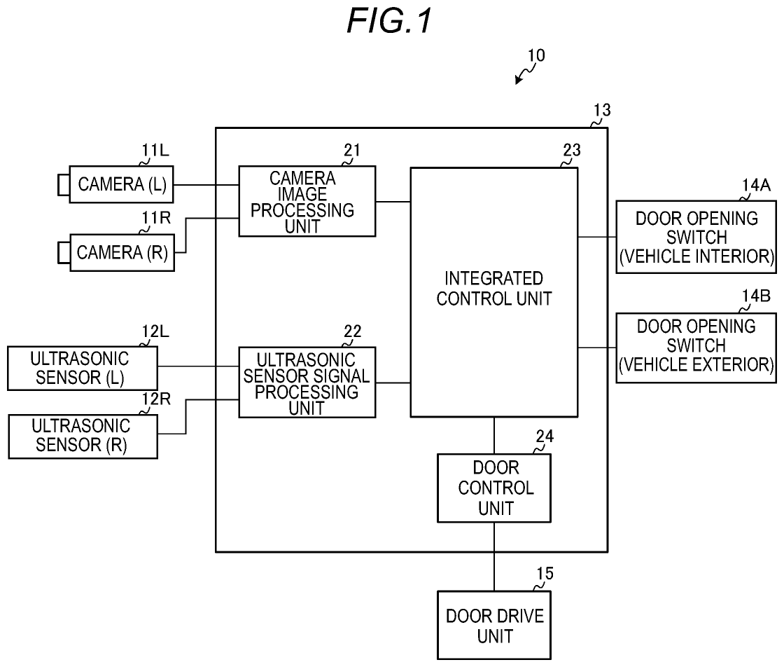

FIG. 1 is a schematic configuration block diagram of an obstacle detection device according to the embodiment.

An obstacle detection device 10 includes a plurality of cameras 11L and 11R, a plurality of ultrasonic sensors 12L and 12R, a controller 13, a door opening switch (vehicle interior) 14A, a door opening switch (vehicle exterior) 14B, and a door drive unit 15.

A plurality of cameras 11-1 to 11-n are disposed at positions where corresponding doors can be imaged, respectively. Further, an imaging range of the cameras 11-1 to 11-n is a range in which the corresponding doors can be imaged from a closed state to a fully opened state.

In the above configuration, the controller 13 is a microcomputer and controls the obstacle detection device 10 based on a control program stored in advance.

The controller 13 controls the entire obstacle detection device 10. The controller 13 includes a camera image processing unit 21, an ultrasonic sensor signal processing unit 22, an integrated control unit 23, and a door control unit 24.

In the above configuration, the camera image processing unit 21 processes camera images output by the plurality of cameras 11L and 11R, and outputs processed results to the integrated control unit 23. In this case, the camera image processing unit 21 determines presence or absence of an obstacle, estimates a shape of the obstacle (object detection), and calculates an allowable door opening degree.

The ultrasonic sensor signal processing unit 22 processes output signals of the plurality of ultrasonic sensors 12L and 12R and outputs processed signals to the integrated control unit 23. In this case, the ultrasonic sensor signal processing unit 22 determines the presence or absence of the obstacle, estimates the shape of the obstacle, and calculates the allowable door opening degree.

The integrated control unit 23 controls the entire controller 13. When the door opening switch (vehicle interior) 14A or the door opening switch (vehicle exterior) 14B is operated, drive control of the door is performed via the door control unit 24 based on outputs of the camera image processing unit 21 and the ultrasonic sensor signal processing unit 22.

The door control unit 24 controls the door drive unit 15 under the control of the integrated control unit 23 to perform drive control of the door (such as control of a door opening degree).

The door opening switch (vehicle interior) 14A is disposed in the vehicle interior and is operated when an occupant opens the door.

The door opening switch (vehicle exterior) 14B is disposed outside a vehicle and is operated, for example, when the occupant opens the door and tries to get into the vehicle.

The door opening switch (vehicle interior) 14A and the door opening switch (vehicle exterior) 14B are mechanical switches, electrostatic switches, or remote controller switches. The door opening switch (vehicle interior) 14A and the door opening switch (vehicle exterior) 14B may also have a software configuration in which a position or action of a user (occupant) is detected by a camera or a radio wave sensor and the door opening switch (vehicle interior) 14A and the door opening switch (vehicle exterior) 14B operate with the detection as a trigger.

The door drive unit 15 performs unlocking/locking control and opening and closing control of the door under the control of the door control unit 24.

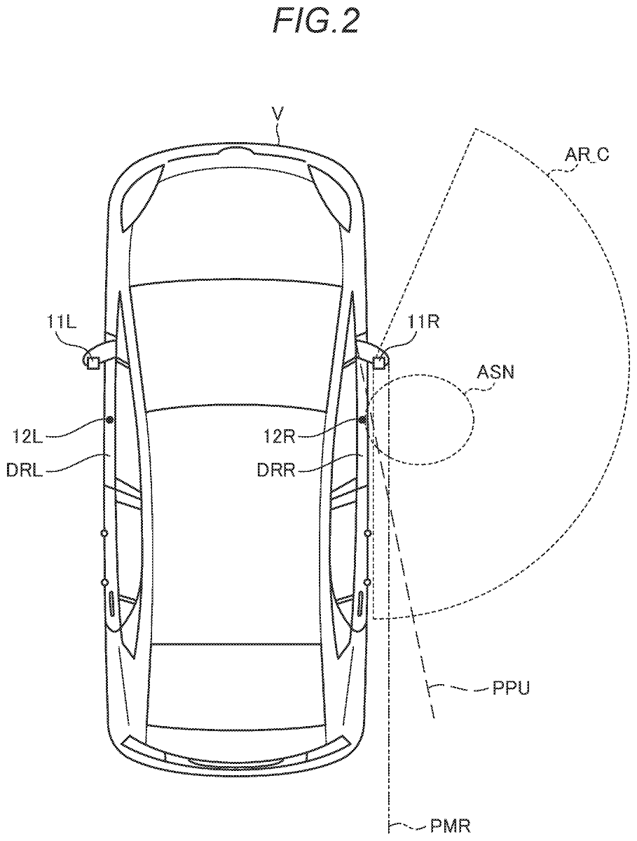

FIG. 2 is a plan view of a vehicle provided with the obstacle detection device according to the embodiment.

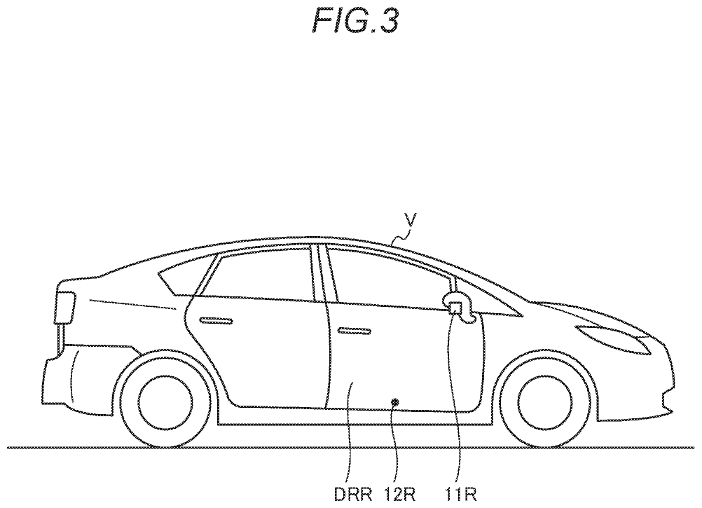

FIG. 3 is a right-side view of the vehicle provided with the obstacle detection device according to the embodiment.

In FIG. 2, for ease of understanding, a case where four cameras 11-1 to 11-4 and ultrasonic sensor groups 12-1 to 12-4 respectively corresponding to the cameras 11-1 to 11-4 are provided will be described as an example.

In FIG. 2, an upward direction is a forward direction of a vehicle V, a downward direction is a rearward direction of the vehicle V, a rightward direction is a rightward direction of the vehicle V, and a leftward direction is a leftward direction of the vehicle V. In FIG. 3, a rightward direction is the forward direction of the vehicle V, and a leftward direction is the rearward direction of the vehicle V.

As shown in FIG. 2 or 3, the camera 11R that captures an image of a right front door is disposed on a right side mirror of the vehicle V. The camera 11L that captures an image of a left front door is disposed on a left side mirror of the vehicle V.

The ultrasonic sensor 12R is disposed in, for example, a garnish at a lower portion of a right front door DRR of the vehicle V. The ultrasonic sensor 12L is disposed in, for example, a garnish at a lower portion of a left front door DRL of the vehicle V.

Here, detection ranges of the cameras and detection ranges of the ultrasonic sensors will be described.

Although the camera 11R and the ultrasonic sensor 12R will be described below for ease of understanding, the same applies to the camera 11L and the ultrasonic sensor 12L.

As shown in FIG. 2, a detection range AR_C of the camera 11R includes a detection range ASN of the ultrasonic sensor 12R.

Next, an operation according to the embodiment will be described.

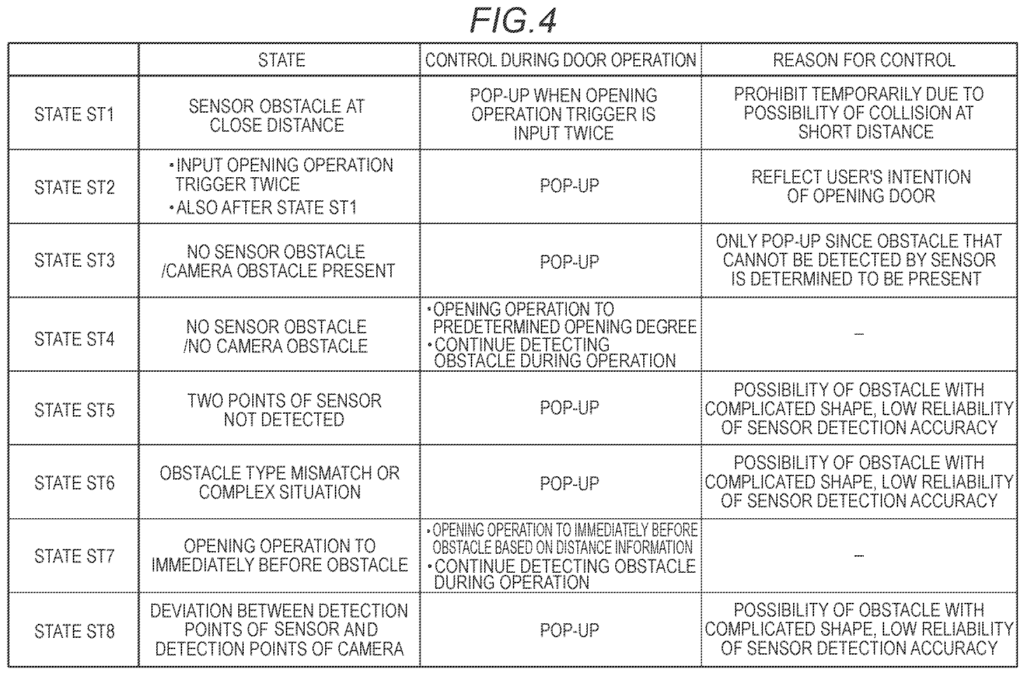

FIG. 4 shows states of the embodiment.

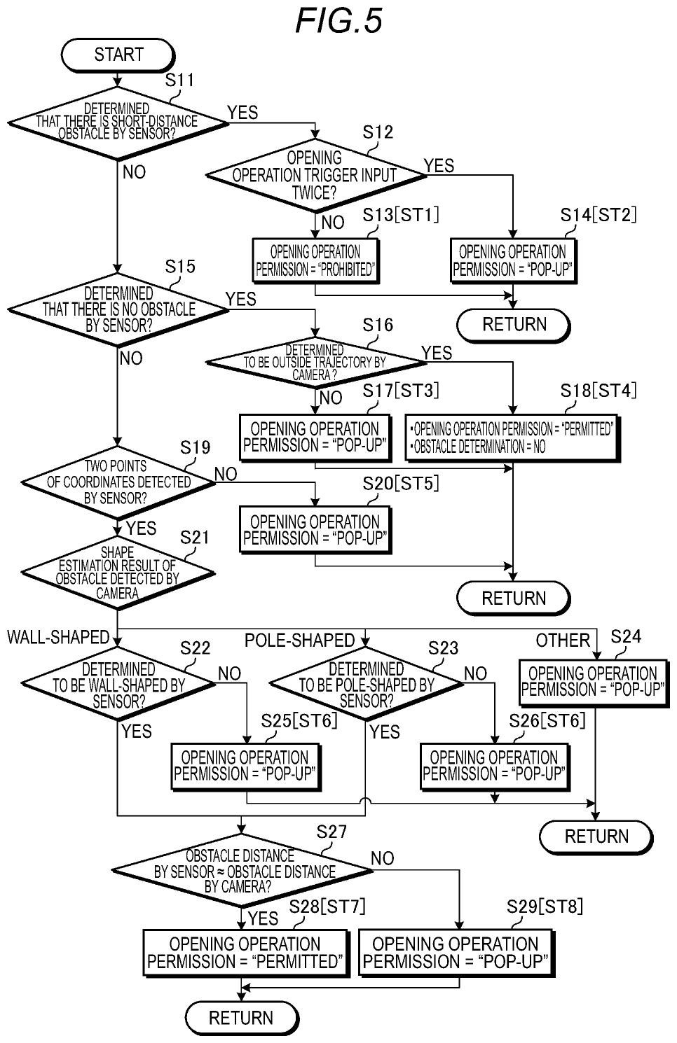

FIG. 5 is an operation flowchart of the embodiment.

First, when the door opening switches 14A and 14B are detected to be in an ON state, the integrated control unit 23 determines whether the ultrasonic sensors 12R and 12L determined that a short distance obstacle is present within a predetermined distance (for example, 300 mm) from the sensors based on the output of the ultrasonic sensor signal processing unit 22 (step S11).

When it is determined in step S11 that the short distance obstacle is present within the predetermined distance from the sensors (step S11; Yes), the integrated control unit 23 performs the determination again and determines whether an opening operation trigger is input twice in the ultrasonic sensors 12R and 12L (step S12).

When it is determined in step S12 that the opening operation trigger is not input twice (step S12; No), the integrated control unit 23 prohibits a door opening operation as shown in a state ST1 of FIG. 4 and ends the process (step S13).

In the state ST1, an opening operation is prohibited temporarily since the vehicle may collide with the short distance obstacle.

When it is determined in step S12 that the opening operation trigger is input twice (step S12; Yes), as shown in a state ST2 of FIG. 4, the integrated control unit 23 permits an opening operation to limit the door opening operation to pop-up and ends the process (step S14).

Here, a position of the pop-up is a state in which a position PPU of an open end of an opened door is accommodated within a range not exceeding the amount of protrusion of a door mirror defined by a two-dotted chain line PMR in FIG. 2.

When it is determined in step S11 that no short distance obstacle is present within the predetermined distance from the sensors, the integrated control unit 23 determines whether the ultrasonic sensors 12R and 12L determined that no obstacle is present at a position away from the sensors by the predetermined distance or more based on the output of the ultrasonic sensor signal processing unit 22 (step S15).

When it is determined in step S15 that no obstacle is present at a position away from the sensors by the predetermined distance or more (step S15; Yes), the integrated control unit 23 determines with the corresponding cameras 11R and 11L whether an obstacle is located outside a door trajectory range when the door is opened (step S16).

When it is determined in step S16 that an obstacle is located within the door trajectory range when the door is opened (step S16; No), as shown in a state ST3 of FIG. 4, the integrated control unit 23 determines that there is an obstacle that cannot be detected by the ultrasonic sensors, permits the opening operation to limit the door opening operation to the pop-up, performs control to maintain the pop-up state, and ends the process (step S17).

When it is determined in step S16 that an obstacle is located outside the door trajectory range when the door is opened (step S16; Yes), the integrated control unit 23 determines that there is no problem in the door opening operation, permits the opening operation, and determines that the obstacle determination=no as shown in a state ST4 of FIG. 4. Further, when an obstacle is detected during an actual door opening operation, the integrated control unit 23 stops the opening operation upon the detection. The process ends when the opening operation is completed or when the opening operation is stopped (step S18).

On the other hand, when it is determined in step S15 that an obstacle is present at a position away from the sensors by the predetermined distance or more (step S15; No), the integrated control unit 23 determines whether two points of coordinates of the obstacle are detected by the ultrasonic sensors 12L and 12R (step S19).

When it is determined in step S19 that the two points of coordinates of the obstacle are not detected by the ultrasonic sensors 12L and 12R (step S19; No), as shown in a state ST5 of FIG. 4, the integrated control unit 23 determines that there is an obstacle having a complicated shape that cannot be accurately detected by the ultrasonic sensors 12L and 12R, or that the reliability of the detection accuracy of the ultrasonic sensors 12L and 12R is low, permits the opening operation to limit the door opening operation to the pop-up, performs control to maintain the pop-up state, and ends the process (step S20).

When it is determined in step S19 that the two points of coordinates of the obstacle are detected by the ultrasonic sensors 12L and 12R (step S19; Yes), the integrated control unit 23 determines which of an obstacle (wall-shaped) of a planar member such as a wall, a columnar obstacle (pole-shaped), and other obstacles the obstacle detected by the cameras 11L and 11R belongs to (step S21).

When it is determined in step S21 that the obstacle detected by the cameras 11L and 11R is an obstacle (wall-shaped) of a planar member such as a wall (step S21; wall-shaped), the integrated control unit 23 determines whether the obstacle detected by the ultrasonic sensors 12L and 12R corresponding to the cameras is a wall-shaped obstacle based on the output of the ultrasonic sensor signal processing unit 22 (step S22).

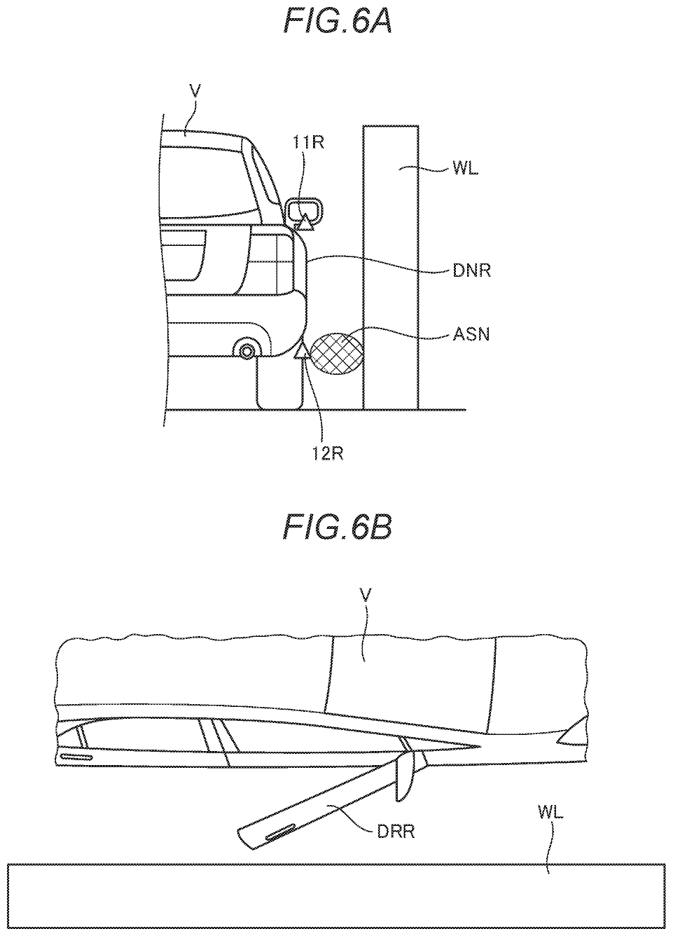

FIGS. 6A and 6B show a state when a wall-shaped obstacle is detected by an ultrasonic sensor.

As shown in FIGS. 6A and 6B, when the obstacle is a wall-shaped obstacle WL, the output of the ultrasonic sensor signal processing unit 22 shows a state in which the obstacle is present at substantially the same distance when the vehicle V is moving, and thus the detection result of the camera image processing unit 21 is an obstacle having a shape of a wall.

When it is determined in step S22 that the obstacle detected by the ultrasonic sensors 12L and 12R corresponding to the cameras is not a wall-shaped obstacle (step S22; No), as shown in a state ST6 of FIG. 4, the integrated control unit 23 determines that there is an obstacle having a complicated shape that cannot be accurately detected by the ultrasonic sensors 12L and 12R, or that the reliability of the detection accuracy of the ultrasonic sensors 12L and 12R is low, permits the opening operation to limit the door opening operation to the pop-up, performs control to maintain the pop-up state as shown in FIG. 6B, and ends the process (step S25).

When it is determined in step S22 that the obstacle detected by the ultrasonic sensors 12L and 12R corresponding to the cameras is a wall-shaped obstacle (step S22; Yes), the integrated control unit 23 shifts the process to step S27.

When it is determined in step S21 that the obstacle detected by the cameras 11L and 11R is a columnar obstacle (pole-shaped) (step S21; pole-shaped), the integrated control unit 23 determines whether the obstacle detected by the ultrasonic sensors 12L and 12R corresponding to the cameras is a pole-shaped obstacle based on the output of the ultrasonic sensor signal processing unit 22 (step S23).

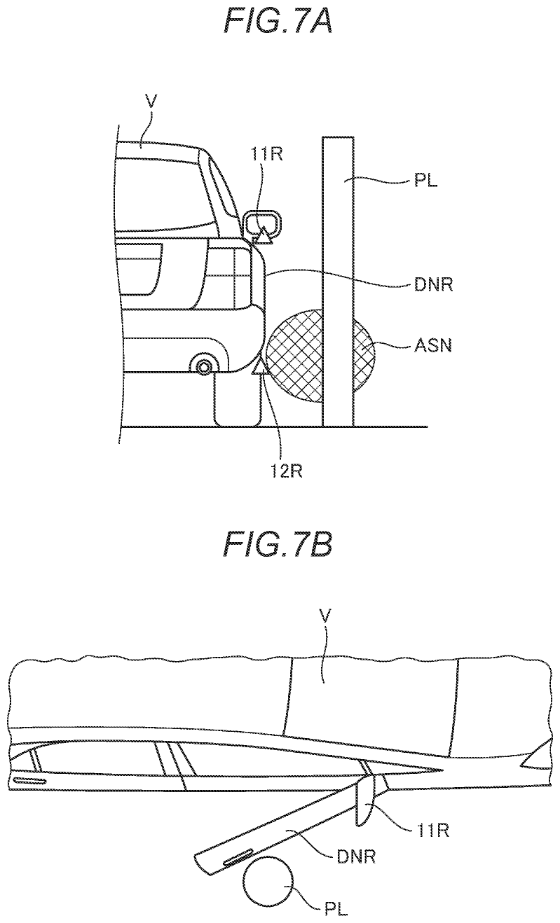

FIGS. 7A and 7B show a state when a pole-shaped obstacle is detected by an ultrasonic sensor.

As shown in FIGS. 7A and 7B, when the obstacle is a pole-shaped obstacle PL, the output of the ultrasonic sensor signal processing unit 22 shows a state in which a distance to the obstacle gradually changes when the vehicle V is moving, and thus the detection result of the camera image processing unit 21 is an obstacle having a shape of pole.

When it is determined in step S23 that the obstacle detected by the ultrasonic sensors 12L and 12R corresponding to the cameras is not a pole-shaped obstacle (step S23; No), as shown in the state ST6 of FIG. 4, the integrated control unit 23 determines that there is an obstacle having a complicated shape that cannot be accurately detected by the ultrasonic sensors 12L and 12R, or that the reliability of the detection accuracy of the ultrasonic sensors 12L and 12R is low, permits the opening operation to limit the door opening operation to the pop-up, performs control to maintain the pop-up state as shown in FIG. 7B, and ends the process (step S26).

When it is determined in step S23 that the obstacle detected by the ultrasonic sensors 12L and 12R corresponding to the cameras is a pole-shaped obstacle (step S23; Yes), the integrated control unit 23 determines whether a detection distance to the obstacle PL by the ultrasonic sensors 12L and 12R is substantially the same as a detection distance to the obstacle PL by the cameras 11L and 11R to such an extent that the detected obstacles can be regarded as the same obstacle (step S27).

When it is determined in step S27 that the detection distance to the obstacle PL by the ultrasonic sensors 12L and 12R is substantially the same as the detection distance to the obstacle PL by the cameras 11L and 11R to such an extent that the detected obstacles can be regarded as the same obstacle (step S27; Yes), the reliability of detection in which there is no deviation between detection points of the ultrasonic sensors 12L and 12R and detection points of the cameras 11L and 11R is high. Accordingly, as shown in a state ST7 of FIG. 4, the integrated control unit 23 permits the opening operation without restricting the door opening operation, continues the obstacle detection based on the detected distance information, performs the door opening operation control until before the obstacle, and ends the process (step S28).

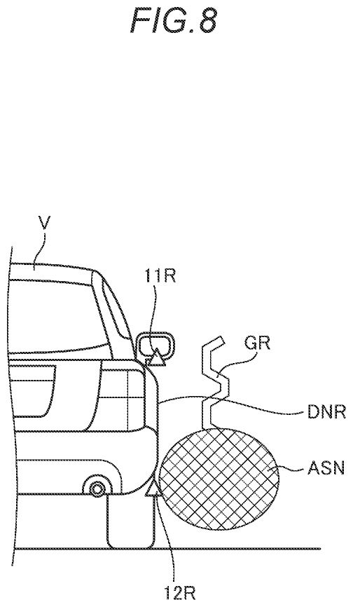

FIG. 8 shows a state when a guardrail, which is an obstacle having a complicated shape, is detected.

When it is determined in step S27 that the detection distance to the obstacle PL by the ultrasonic sensors 12L and 12R is different from the detection distance to the obstacle PL by the cameras 11L and 11R to such an extent that the detected obstacles cannot be regarded as the same obstacle (step S27; No), as shown in a state ST8 of FIG. 4, the integrated control unit 23 determines that the detection points of the ultrasonic sensors 12L and 12R and the detection points of the cameras 11L and 11R are deviated from each other, there is an obstacle having a complicated shape that cannot be accurately detected by the ultrasonic sensors 12L and 12R as shown by a guardrail GR in FIG. 8, or that the reliability of the detection accuracy of the ultrasonic sensors 12L and 12R is low, permits the opening operation to limit the door opening operation to the pop-up, performs control to maintain the pop-up state, and ends the process (step S29).

When it is determined in step S21 that the obstacle detected by the cameras 11L and 11R is neither a wall-shaped obstacle nor a pole-shaped obstacle (step S21; other), as shown in the state ST5 of FIG. 4, the integrated control unit 23 determines, based on the output of the ultrasonic sensor signal processing unit 22 and the output of the camera image processing unit 21, that a result of an obstacle type of the ultrasonic sensors 12L and 12R does not match a result of an obstacle type of the cameras 11L and 11R, or there is an obstacle having a complicated shape that cannot be accurately detected by the ultrasonic sensors 12L and 12R, such as the guardrail GR shown in FIG. 8, or that the reliability of the detection accuracy of the ultrasonic sensors 12L and 12R is low, permits the opening operation to limit the door opening operation to the pop-up, performs control to maintain the pop-up state, and ends the process (step S24).

As described above, according to the present embodiment, when a signal for opening the door is input from the door opening switches 14A and 14B for opening the door, the door opening control for increasing the door opening degree as much as possible can be performed, and the door opening control for easily getting on and off the vehicle can be performed.

Further, the door can be avoided from colliding with the obstacle.

When the distance to the obstacle is detected by the camera image processing unit 21 and the ultrasonic sensor signal processing unit 22 and the detection results are almost the same (when the detection results can be regarded as the same), the opening operation until before the obstacle is permitted. Accordingly, it is possible to prevent the door from colliding with the obstacle even when the obstacle has a shape that is difficult to detect by ultrasonic sensors SN1 and SN2.

Although the embodiment disclosed here has been described above, the above-described embodiment and modifications are merely examples, and the scope of the disclosure is not intended to be limited thereto. The embodiment and modifications described above can be carried out in various other forms, and various omissions, replacements, combinations, and changes can be made without departing from the scope of the disclosure. Further, a part of the configurations and shapes of the embodiment and modifications can be exchanged.

For example, in the above embodiment, the obstacle detection device 10 includes, for example, one controller (ECU) 13, but the disclosure is not limited thereto. The obstacle detection device 10 may be constituted by a plurality of ECUs. For example, one ECU may be responsible for functions of the camera image processing unit 21 and the ultrasonic sensor signal processing unit 22, and the other ECUs may be responsible for functions of the integrated control unit 23 and the door control unit 24.

In the above description, a case where an ultrasonic sensor is used as a distance measuring sensor is described. Alternatively, the distance measuring sensor may also use another type of sensors such as a radio wave sensor or an infrared sensor.

An obstacle detection device according to an embodiment including: an ultrasonic sensor signal processing unit configured to detect, of a distance to an obstacle and a shape of the obstacle, at least the distance based on an output of an ultrasonic sensor disposed in a door of a vehicle, the ultrasonic sensor being configured to detect the distance to the obstacle within a predetermined detection range by ultrasonic waves; a camera image processing unit configured to detect at least one of the distance to the obstacle and the shape of the obstacle based on an output of a camera of the vehicle, the camera being configured to image an area including a trajectory range of the door of the vehicle when being opened and a detection range of the ultrasonic sensor; and a controller configured to perform an opening operation control of opening the door to a pop-up position based on a detection result of the ultrasonic sensor signal processing unit and a detection result of the camera image processing unit when the distance to the obstacle is less than a predetermined distance.

According to such a configuration, it is possible to avoid a collision with the obstacle in various situations, for example, stopping the door immediately before colliding with the obstacle.

When it is determined that detection accuracy of the ultrasonic sensor is low, the controller may hold a door opening degree at the pop-up position.

According to the above configuration, even when the detection accuracy of the ultrasonic sensor is low, the collision with the obstacle can be avoided more reliably.

When the distance to the obstacle is less than or equal to a second predetermined distance shorter than the predetermined distance, the controller may prohibit an opening operation in a releasable manner.

According to the above configuration, even when the obstacle is located at a short distance such as the second predetermined distance, the collision with the obstacle can be avoided.

The controller may perform the opening operation control when it is determined that the distance to the obstacle and the shape of the obstacle in the detection result of the ultrasonic sensor signal processing unit are the same as the distance to the obstacle and the shape of the obstacle in the detection result of the camera image processing unit.

According to the above configuration, it is possible to perform the opening operation control with high detection accuracy.

The controller may perform the opening operation control of opening the door before reaching the distance to the obstacle in the detection result of the ultrasonic sensor signal processing unit when the distance to the obstacle in the detection results of the ultrasonic sensor signal processing unit is equal to or more than the predetermined distance.

According to the above configuration, it is possible to avoid the collision with an obstacle and make it convenient to get on and off the vehicle.

A method according to an embodiment is a method performed by an obstacle detection device to which an output from an ultrasonic sensor disposed in a door of a vehicle and an output of a camera of the vehicle are input, the ultrasonic sensor being configured to detect a distance to an obstacle within a predetermined detection range by ultrasonic waves, the camera being configured to image an area including a trajectory range of the door of the vehicle when being opened and a detection range of the ultrasonic sensor, the method including: a first step of detecting, of the distance to the obstacle and a shape of the obstacle, at least the distance based on the output of the ultrasonic sensor; a second step of detecting at least one of the distance to the obstacle and the shape of the obstacle based on the output of the camera; and a third step of performing an opening operation control of opening the door to a pop-up position based on detection results of the first step and the second step when the distance to the obstacle is less than a predetermined distance.

According to such a configuration, it is possible to avoid a collision with the obstacle in various situations, for example, stopping the door immediately before colliding with the obstacle.

A program according to an embodiment is a program that controls, by a computer, an obstacle detection device to which an output from an ultrasonic sensor disposed in a door of a vehicle and an output of a camera of the vehicle are input, the ultrasonic sensor being configured to detect a distance to an obstacle within a predetermined detection range by ultrasonic waves, the camera being configured to image an area including a trajectory range of the door of the vehicle when being opened and a detection range of the ultrasonic sensor, the program causing the computer to function as: a first unit configured to detect, of the distance to the obstacle and a shape of the obstacle, at least the distance based on the output of the ultrasonic sensor; a second unit configured to detect at least one of the distance to the obstacle and the shape of the obstacle based on the output of the camera; and a third unit configured to perform an opening operation control of opening the door to a pop-up position based on detection results of the first unit and the second unit when the distance to the obstacle is less than a predetermined distance.

According to such a configuration, it is possible to avoid a collision with the obstacle in various situations, for example, stopping the door immediately before colliding with the obstacle.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An obstacle detection device comprising:
an ultrasonic sensor signal processing unit configured to detect, of a distance to an obstacle and a shape of the obstacle, at least the distance based on an output of an ultrasonic sensor disposed in a door of a vehicle, the ultrasonic sensor being configured to detect the distance to the obstacle within a predetermined detection range by ultrasonic waves;
a camera image processing unit configured to detect at least one of the distance to the obstacle and the shape of the obstacle based on an output of a camera of the vehicle, the camera being configured to image an area including a trajectory range of the door of the vehicle when being opened and a detection range of the ultrasonic sensor; and
a controller configured to perform an opening operation control of opening the door to a pop-up position based on a detection result of the ultrasonic sensor signal processing unit and a detection result of the camera image processing unit when the distance to the obstacle is less than a predetermined distance.

2. The obstacle detection device according to claim 1, wherein
when it is determined that detection accuracy of the ultrasonic sensor is low, the controller holds a door opening degree at the pop-up position.

3. The obstacle detection device according to claim 1, wherein
when the distance to the obstacle is less than or equal to a second predetermined distance shorter than the predetermined distance, the controller prohibits an opening operation in a releasable manner.

4. The obstacle detection device according to claim 1, wherein
the controller performs the opening operation control when it is determined that the distance to the obstacle and the shape of the obstacle in the detection result of the ultrasonic sensor signal processing unit are the same as the distance to the obstacle and the shape of the obstacle in the detection result of the camera image processing unit.

5. The obstacle detection device according to claim 4, wherein
the controller performs the opening operation control of opening the door before reaching the distance to the obstacle in the detection result of the ultrasonic sensor signal processing unit when the distance to the obstacle in the detection result of the ultrasonic sensor signal processing unit is equal to or more than the predetermined distance.

6. A method performed by an obstacle detection device to which an output from an ultrasonic sensor disposed in a door of a vehicle and an output of a camera of the vehicle are input, the ultrasonic sensor being configured to detect a distance to an obstacle within a predetermined detection range by ultrasonic waves, the camera being configured to image an area including a trajectory range of the door of the vehicle when being opened and a detection range of the ultrasonic sensor, the method comprising:
a first step of detecting, of the distance to the obstacle and a shape of the obstacle, at least the distance based on the output of the ultrasonic sensor;
a second step of detecting at least one of the distance to the obstacle and the shape of the obstacle based on the output of the camera; and
a third step of performing an opening operation control of opening the door to a pop-up position based on detection results of the first step and the second step when the distance to the obstacle is less than a predetermined distance.

7. A program that controls, by a computer, an obstacle detection device to which an output from an ultrasonic sensor disposed in a door of a vehicle and an output of a camera of the vehicle are input, the ultrasonic sensor being configured to detect a distance to an obstacle within a predetermined detection range by ultrasonic waves, the camera being configured to image an area including a trajectory range of the door of the vehicle when being opened and a detection range of the ultrasonic sensor, the program causing the computer to function as:
a first unit configured to detect, of the distance to the obstacle and a shape of the obstacle, at least the distance based on the output of the ultrasonic sensor;
a second unit configured to detect at least one of the distance to the obstacle and the shape of the obstacle based on the output of the camera; and
a third unit configured to perform an opening operation control of opening the door to a pop-up position based on detection results of the first unit and the second unit when the distance to the obstacle is less than a predetermined distance.
